(19) United States
(12) Patent Application Publication
(10) Pub. No.: US 2025/0170528 A1
(43) Pub. Date: May 29, 2025

(54) Method and Apparatus for the Separation or Combination of Fluids

(71) Applicant: The University of Manchester, Manchester (GB)

(72) Inventors: Sebastian James Allender Leaper, Manchester (GB); Ahmed Abdelkarim, Manchester (GB)

(21) Appl. No.: 18/837,572

(22) PCT Filed: Feb. 10, 2023
(86) PCT No.: PCT/GB2023/050310

§ 371 Date: Aug. 9, 2024

(30) Foreign Application Priority Data
Feb. 11, 2022 (GB) 2201820.4
Feb. 11, 2022 (GB) 2201823.8
Mar. 1, 2022 (GB) 2202830.2

(51) Int. Cl. B01D 63/04; B01D 61/36; B01D 69/02; B01F 23/232

(52) U.S. Cl. CPC B01D 63/043; B01D 61/364; B01D 61/366; B01D 69/02; B01F 23/232; B01D 2313/041; B01D 2319/04; B01D 2325/38

(57) ABSTRACT

An apparatus 1 for the separation or combination of fluids comprising an outer conduit 2, at least one inner conduit 3 disposed within the outer conduit 2 and a plurality of hollow fibre membranes 4 disposed within the at least one inner conduit 3. A first fluid passageway 9 is provided between the outer conduit 2 and the at least one inner conduit 3. At least one second fluid passageway 10 is provided between the at least one inner conduit 3 and the plurality of hollow fibre membranes 4. A plurality of third fluid passageways 11 are provided within the plurality of hollow fibre membranes 4. Each of the plurality of the hollow fibre membranes 4 comprises a hydrophobic material through which vapour and/or gas is passable such that, during use, a vaporous permeate is separable from or a gas is combinable with a fluid that is within one of the at least one second fluid passageway 10 and the plurality of third fluid passageways 11.

This invention relates to an apparatus and methods for the separation or combination of fluids. More particularly, the invention relates to an apparatus for the separation or combination of fluid comprising hollow fibre membranes and methods of using the apparatus.

### BACKGROUND

The prior art shows that membranes are used to assist in the separation of or the combination of fluids. For example, hollow fibre membranes may be used to extract fresh water from wastewater or aqueous brine. Additionally, hollow fibre membranes may be used to combine a gas with a liquid.

Using membranes to assist the separation or combination of fluids is advantageous over other distillation techniques because it can be done at lower operating temperatures and pressures, can be used for a wide range of distillation processes and can be highly selective in the permeates and gases which are allowed to pass through the membranes. However, it can be challenging for the separation or combination of fluids using membranes to be cost effective and energy efficient.

It is an object of embodiments of the invention to at least mitigate one or more problems associated with known arrangements.

### BRIEF SUMMARY OF THE DISCLOSURE

In accordance with an aspect of the present invention there is provided an apparatus for the separation or combination of fluids comprising:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which vapour and/or gas is passable such that, during use, a vaporous permeate is separable from or a gas is combinable with a fluid that is within one of the at least one second fluid passageway and the plurality of third fluid passageways.

In certain embodiments, the at least one inner conduit may comprise a plurality of inner conduits.

The apparatus may comprise a potting material configured to fixedly position the plurality of hollow fibre membranes within the at least one inner conduit.

The outer conduit and/or the at least one inner conduit may comprise an impermeable material. The at least one the inner conduit may comprise a thermally conductive material.

In certain embodiments, the apparatus may comprise a common fluid passageway fluidly connecting an outlet of the first fluid passageway to an inlet the plurality of third fluid passageways. The common fluid passageway may comprise heating means configured to heat fluid in the common fluid passageway.

In certain embodiments, the apparatus may comprise a common fluid passageway fluidly connecting an outlet of the plurality of third fluid passageways to an inlet of the first fluid passageway. The common fluid passageway may comprise a vacuum pump, a fan or a compressor.

In certain embodiments, the apparatus may comprise: a first collar securable to an end of the outer conduit; a first insert releasably securable to the first collar; and a plurality of first o-rings arranged between the first collar and the first insert, wherein each of the first collar and the first insert comprise a plurality of apertures and the plurality of inner conduits extend through the first collar and the first insert via the apertures; wherein one of the first o-rings surrounds each of the inner conduits; and wherein the first insert is securable to the first collar such that each of the first o-rings are compressed to sealing engage one of the inner conduits.

One of the first collar and the first insert may comprise a groove extending circumferentially around each aperture, the grooves being configured to receive the first o-rings between the first collar and the first insert; and wherein the height of the first o-rings is greater than the height of the grooves.

Each of the first collar and the first insert may comprise a groove extending circumferentially around each aperture, the grooves being configured to receive the first o-rings between the first collar and the first insert; and wherein the height of the first o-rings is greater than the combined height of the grooves in the first insert and the first collar.

The first insert may be releasably securable to the first collar by at least one threaded fastener. The first insert may be releasably securable to the first collar by a plurality of threaded fasteners.

The first collar may be releasably securable to the outer conduit. The first collar may be releasably securable to the outer conduit by at least one threaded fastener. The first collar may be releasably securable to the outer conduit by a plurality of threaded fasteners.

In certain embodiments, each of the plurality of inner conduits may comprises a bundle of hollow fibre membranes disposed therein and each bundle comprises a support configured to secure the hollow fibre membranes together.

The support may be configured to fixedly position the plurality of hollow fibre membranes relative to one another.

The support may comprise a potting material.

In certain embodiments, the apparatus may comprise: a second collar securable to the first collar; a second insert releasably securable to the second collar; and a plurality of second o-rings arranged between the second collar and the second insert; wherein each of the second collar and the second insert comprise a plurality of apertures, each aperture being configured to receive one of the supports so that the plurality of hollow fibre membranes extend through the second collar and the second insert; wherein one of the second o-rings surrounds each of the supports; and wherein the second insert is securable to the second collar such that each of the second o-rings are compressed to sealing engage one of the supports.

One of the second collar and the second insert may comprise a groove extending circumferentially around each aperture, the grooves being configured to receive the second o-rings between the second collar and the second insert; and wherein the height of the second o-rings is greater than the height of the grooves.

Each of the second collar and the second insert may comprise a groove extending circumferentially around each aperture, the grooves being configured to receive the second o-rings between the second collar and the second insert; and wherein the height of the second o-rings is greater than the combined height of the grooves in the second insert and the second collar.

The second insert may be releasably securable to the second collar by at least one threaded fastener. The second insert may be releasably securable to the second collar by a plurality of threaded fasteners.

The second collar may be releasably securable to the first collar. The second collar may be releasably securable to first collar by at least one threaded fastener. The second collar may be releasably securable to first collar by a plurality of threaded fasteners.

In certain embodiments, the apparatus may comprise a cap releasably securable to the second collar.

In certain embodiments, the first collar may comprise an opening configured to allow fluid to enter or exit the second fluid passageways.

In certain embodiments, the cap may comprise an opening configured to allow fluid to enter or exit the third fluid passageways.

In certain embodiments, the outer conduit may comprise at least one opening configured to allow fluid to enter or exit the first fluid passageway.

In accordance with another aspect of the present invention there is provided a method of fluid separation comprising:
providing the above-described apparatus;
feeding a feed fluid through the plurality of third fluid passageways; and
extracting a permeate of the feed fluid from the at least one second fluid passageway;
wherein the vapour pressure in the plurality of third fluid passageways is greater than the vapour pressure in the at least one second fluid passageway.

The method may comprise feeding a coolant through the first fluid passageway to condense at least part of the permeate of the feed fluid in the at least one second fluid passageway; wherein the temperature of the coolant is lower than the temperature of the feed fluid.

The method may comprise extracting the coolant from the first fluid passageway and heating the extracted coolant to provide the feed fluid.

In certain embodiments, the at least one second fluid passageway may comprise air, a partial vacuum, a vacuum, a porous material or a liquid.

Extracting the permeate of the feed fluid from the at least one second fluid passageway may comprise feeding a sweep gas through the at least one second fluid passageway.

Feeding the feed fluid through the plurality of third fluid passageways may comprise feeding the feed fluid at a pressure that is less than the liquid entry pressure of the hydrophobic material of the plurality of the hollow fibre membranes.

In accordance with another aspect of the present invention there is provided a method of fluid separation comprising:
providing the above-described apparatus;
feeding a feed fluid through the at least one second fluid passageway; and
extracting a permeate of the feed fluid from the plurality of third fluid passageways;
wherein the vapour pressure in the at least one second fluid passageway is greater than the vapour pressure in the plurality of third fluid passageways.

The method may comprise feeding the permeate of the feed fluid through the first fluid passageway to condense the permeate of the feed fluid.

The method may comprise increasing the temperature and pressure of the permeate of the feed fluid before feeding the permeate of the feed fluid through the first fluid passageway.

In certain embodiments, the plurality of third fluid passageways may comprise air, a partial vacuum, a vacuum, a porous material or a liquid.

In certain embodiments, extracting the permeate of the feed fluid from the plurality of third fluid passageways may comprise feeding a sweep gas through the plurality of third fluid passageways.

Feeding the feed fluid through the at least one second fluid passageway may comprise feeding the feed fluid at a pressure that is less than the liquid entry pressure of the hydrophobic material of the plurality of the hollow fibre membranes.

In accordance with another aspect of the present invention there is provided a method for combining a gas with a liquid comprising:
providing the above-described apparatus;
feeding a feed liquid through one of the at least one second fluid passageway and the plurality of third fluid passageways; and
feeding a gas for combining with the feed liquid through the other of the at least one second fluid passageways and the plurality of third fluid passageways.

The method may comprise applying pressure to drive the gas through the plurality of the hollow fibre membranes.

The method may comprise regulating the temperature in the at least one second fluid passageway by feeding a regulating fluid through the first fluid passageway.

In certain embodiments, the feed fluid may be fed through the at least one second fluid passageway and the temperature of the regulating fluid may be greater than the temperature of the feed fluid.

According to another aspect of the invention there is provided a fluid separation apparatus comprising:
an outer conduit;
at least one inner conduit disposed within the outer conduit; and
a plurality of hollow fibre membranes disposed within each of the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein the plurality of third fluid passageways are configured to receive a feed fluid;
wherein each of the plurality of the hollow fibre membranes comprises a hydrophobic material through which vapour is passable such that, during use, a vaporous permeate of the feed fluid is separable from the feed fluid into the at least one second fluid passageways; and
wherein the vapour pressure in the plurality of third fluid passageways is greater than the vapour pressure in the at least one second fluid passageway.

In certain embodiments, the first fluid passageway may be configured to receive a coolant to condense at least part of the permeate of the feed fluid in the at least one second fluid passageways, wherein the temperature of the coolant is lower than the temperature of the feed fluid.

According to another aspect of the invention there is provided a fluid separation apparatus comprising:
an outer conduit;
at least one inner conduit disposed within the outer conduit; and
a plurality of hollow fibre membranes disposed within each of the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein the at least one second fluid passageway is configured to receive a feed fluid;
wherein each of the plurality of the hollow fibre membranes comprises a hydrophobic material through which vapour is passable such that, during use, a vaporous permeate of the feed fluid is separable from the feed fluid into the plurality of third fluid passageways;
wherein the vapour pressure in the at least one second fluid passageway is greater than the vapour pressure in the plurality of third fluid passageways.

According to another aspect of the invention there is provided a gas contactor comprising:
an outer conduit;
at least one inner conduit disposed within the outer conduit; and
a plurality of hollow fibre membranes disposed within each of the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein the at least one second fluid passageway or the plurality of third fluid passageways is configured to receive a liquid and the other of the at least one second fluid passageway or the plurality of third fluid passageways is configured to receive a gas;
wherein each of the plurality of the hollow fibre membranes comprises a hydrophobic material through which the gas is passable such that, during use, the gas passes through the hydrophobic material for absorption by the liquid.

### BRIEF DESCRIPTION OF THE DRAWINGS

Embodiments of the invention are further described hereinafter with reference to the accompanying drawings, in which:

FIG. 1 schematically shows a sectional side-view of an apparatus according to an embodiment of the present invention;

FIG. 2 schematically shows a cross-section of the apparatus of FIG. 1;

FIG. 3 schematically shows a cross-section of a part of the apparatus of FIG. 1;

FIG. 4 schematically shows an apparatus according to an embodiment of the present invention;

FIG. 5 schematically shows an apparatus according to an embodiment of the present invention; and

FIGS. 6 and 7 schematically show an apparatus according to an embodiment of the present invention.

### DETAILED DESCRIPTION

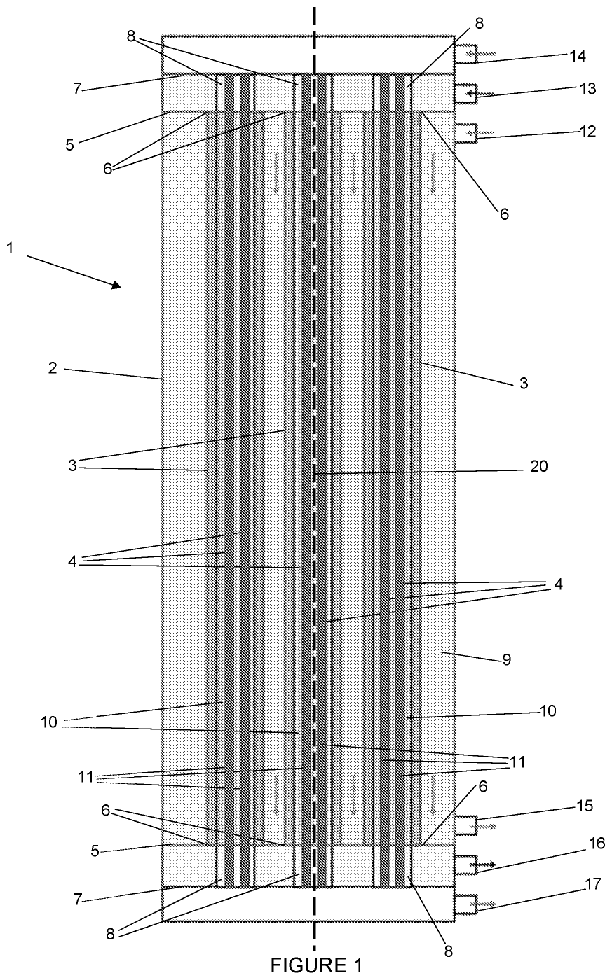

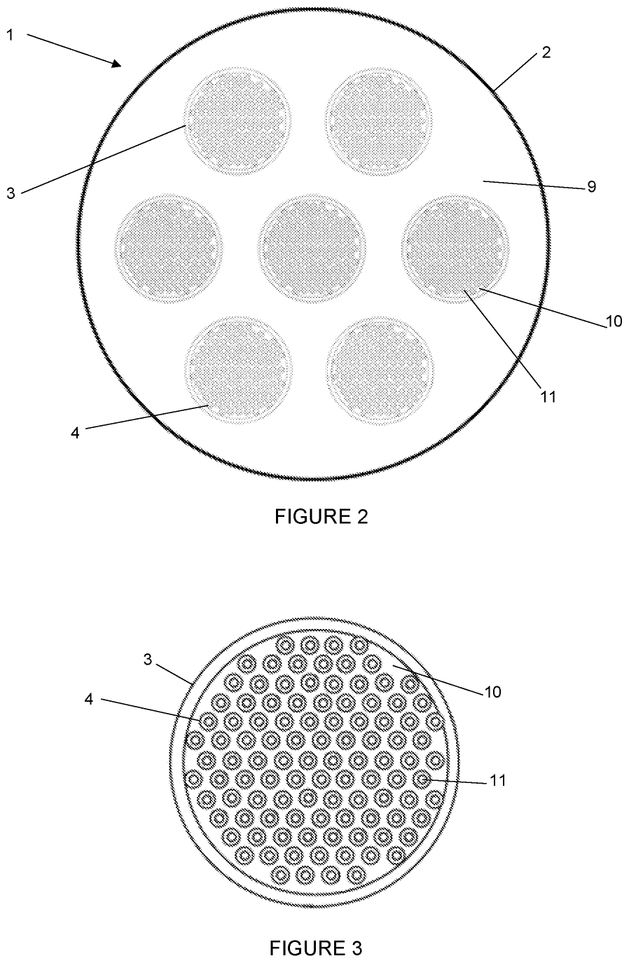

FIGS. 1 and 2 show an apparatus 1 according to an embodiment of the invention. The apparatus 1 is suitable for use in both the separation of and the combination of fluids.

As shown in FIGS. 1 and 2, the apparatus 1 comprises an outer conduit 2. The outer conduit 2 is elongate in shape and has a longitudinal axis 20. In the embodiment shown in FIGS. 1 and 2, the outer conduit 2 is tubular i.e. the outer conduit 2 has a circular cross-section. However, in alternative embodiments, the cross-section of the outer conduit 2 may have a different shape. For example, the cross-section may be hexagonal or rectangular.

The outer conduit 2 may comprise an impermeable material. That is, a material through which fluid cannot pass. Non-limiting examples of suitable impermeable materials include acrylonitrile butadiene styrene (ABS), polypropylene, polyvinyl chloride (PVC), stainless steel and other metallic materials. The outer conduit 2 may be formed from stainless steel or metallic materials when high pressures, for example pressures at or above 10 bar, will be used to separate or combine fluids such as when combing a gas with a liquid.

Within the outer conduit 2, the apparatus 1 comprises at least one inner conduit 3. The inner conduit 3 extends substantially along the length of the outer conduit 2. In the non-limiting embodiment shown in the FIGS. 1 and 2, the apparatus 1 comprises a plurality of inner conduits 3, namely, seven inner conduits 3. However, in alternative embodiments the apparatus 1 may comprise a different number of inner conduits 3. As shown in FIG. 2, the plurality of inner conduits 3 may be uniformly distributed within the outer conduit 2.

Each of the inner conduits 3 of FIGS. 1 and 2 is elongate in shape. A longitudinal axis (not shown) of each inner conduit 3 is parallel to the longitudinal axis 20 of the outer conduit 2. As such, the outer conduit 2 and the plurality of inner conduits 3 are parallel to one another.

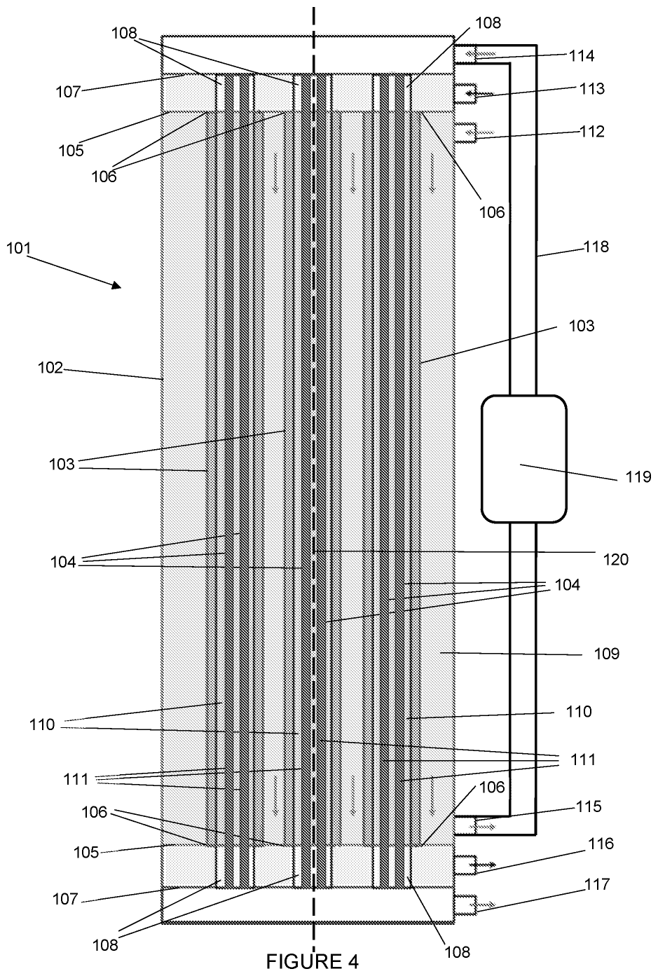

As shown in FIGS. 2 and 3, the plurality of inner conduits 3 are tubular (i.e. the inner conduits 3 have a circular cross-sections). The diameters of all of the inner conduits 3 in the apparatus may be the same as one another. However, in alternative embodiments, the cross-section of the inner conduits may have different shapes and/or may have a range of different sizes. For example, the cross-section may be hexagonal or rectangular and the diameters of the inner conduits may differ from one another.

Each inner conduit 3 may comprise an impermeable material. Each inner conduit 3 may comprise a thermally conductive material. For example, each inner conduit 3 may comprise a graphite-polymer composite. The graphite of each inner conduit 3 may be radially aligned relative to the longitudinal axis of the inner conduit 3 to improve its thermal conductivity. The polymer is included in the composite to reduce the risk of corrosion of the inner conduit 3 during use. Additionally, the polymer may improve the ease of washing off of any crystals that are formed on the inner conduit 3 during use. The polymer used in the composite may depend on the temperatures associated with the intended use of the apparatus. For example, the polymer may comprise polyvinyl chloride (PVC) when the temperature in the apparatus will not exceed 60° C. during use. Alternatively, the polymer may comprise polypropylene or polyphenylene sulphide (PPS) when the temperature in the apparatus will exceed 60° C. during use.

Within each of the inner conduits 3, the apparatus 1 comprises a plurality of hollow fibre membranes 4. Thus, a bundle of hollow fibre membranes 4 is within each inner conduit 3. As shown in the embodiment of FIGS. 1 to 3, each of the inner conduits 3 may contain the same number of hollow fibre membranes 4. The plurality of hollow fibre membranes 4 may be uniformly distributed within each inner conduit 3.

As shown in the embodiment in FIGS. 1 and 3, each of plurality of hollow fibre membranes 4 may be tubular in shape. The diameters of all of the hollow fibre membranes 4 in the apparatus 1 may be the same as each other. Each hollow fibre membrane 4 has a longitudinal axis which is substantially parallel to the longitudinal axis 20 of the outer conduit 2. As such, the outer conduit 2, the plurality of inner conduits 3 and the plurality of hollow fibre membranes 4 are substantially parallel with one another. In the embodiment shown in FIGS. 1 and 2, each of the plurality of hollow fibre membranes 4 extends at least along the length of the outer conduit 2 and the plurality of inner conduits 3.

The plurality of hollow fibre membranes 4 comprise a hydrophobic material through which vapour and/or gas is passable during use. As such, vapour and/or gas may pass into or out of the hollow fibre membranes 4 to facilitate the separation of or the combination of fluids within the apparatus 1. The hydrophobic material comprises a plurality of pores through which the vapour and/or gas pass. The pore size may be from 0.1 to 10 microns or from 0.1 to 1 microns. Alternatively, the pore size may be less than 0.1 microns if a vacuum is applied either inside or outside the plurality of hollow fibre membranes 4 of the apparatus 1 during use. The hydrophobic material may be formed from any suitable material. Examples of suitable materials include polymeric and ceramic materials. For example, the hydrophobic material may comprise polyvinylidene fluoride which is a thermally and a chemically stable material. Alternative non-limiting examples for the hydrophobic materials include polyethersulfone, polysulfone, cellulose acetate, nylon, polypropylene, polyethylene, polytetrafluoroethylene and polyacrylonitrile. Additionally, combinations of polymers may be used for the hydrophobic material. In certain embodiments, the hydrophobic material may comprise a material which repels oil or oil-like substances in addition to water. That is, the hydrophobic material may comprise an omniphobic material.

At each end, the membrane distillation apparatus 1 comprises a first cap 5 configured to fluidly seal the outer conduit 2. The first cap 5 may be welded to the outer conduit 2 to provide a fluid tight seal.

The first cap 5 comprises a plurality of apertures 6. Through each aperture 6, one of plurality of inner conduits 3 extends. Each inner conduit 3 may be welded to its corresponding aperture 6 in the first cap 5 to provide a fluid tight seal.

As shown in FIG. 1, at each end the membrane distillation apparatus 1 also comprises a second cap 7 configured to fluidly seal the plurality of inner conduits 3. The second cap 7 may be welded to the plurality of inner conduits to provide a fluid tight seal. The plurality of hollow fibre membranes 4 extend through at least part of the second cap 7. As shown in the embodiment to FIG. 1, the second cap 7 may also be configured to fluidly seal the plurality of hollow fibre membranes 4. In alternative embodiments, the plurality of hollow fibre membranes 4 may be fluidly sealed by another suitable means. For example, the bundle of hollow fibre membranes 4 in each inner conduit 3 may be fluidly sealed by a separate cap.

As shown in FIG. 1, the plurality of hollow fibre membranes 4 within each inner conduit 3 may be held in a fixed position relative the inner conduit 3 in the second cap 7. The apparatus comprises a potting material 8 to hold each of the plurality of hollow fibre membranes 4 in position. The potting material 8 may comprise a solid cylinder having a plurality of apertures (not shown) through which the plurality of hollow fibre membranes 4 extend. Each of the hollow fibre membranes 5 may be fixed to the plurality of apertures in the solid cylinder with additional potting material 8. As such, the hollow fibre membranes 4 may be held in a fixed position relative to the plurality of inner conduits 3 at either end of the apparatus 1. The potting material 8 may comprise any suitable material for fixing the plurality of hollow fibre membranes 4 in place. Suitable potting materials include but are not limited to epoxy, polyurethane and silicone adhesives.

The arrangement of the outer conduit 2, the at least one inner conduit 3 and the plurality of hollow fibre membranes 5 provides fluid passageways through the apparatus.

A first fluid passageway 9 is provided between the outer conduit 2 and the at least one inner conduit 3. As such, in the embodiment shown in FIGS. 1 and 2, fluid can flow in the volume between the outside of the plurality of inner conduits 3 and the inside of the outer conduit 2 during use.

The apparatus 1 also comprises at least one second fluid passageway 10. Each second fluid passageway 10 is provided between one of the inner conduits 3 and the plurality of hollow fibre membranes 4 within that conduit 3. As such, during use fluid can flow in the volume between the outside of the plurality of hollow fibre membranes 4 and the inside of the inner conduit 3 within which the hollow fibre membranes 4 are located. In the embodiment shown in FIGS. 1 and 2, the apparatus 1 comprises a plurality of second fluid passageways 10 as the apparatus comprises a plurality of inner conduits 3. In embodiments where the apparatus comprises only one inner conduit 3, the apparatus 1 provides a single second fluid passageway 10.

A plurality of third fluid passageways 11 is provided in the apparatus 1. One of the plurality of third fluid passageways 11 is provided within each of the plurality of hollow fibre membranes 4 of the apparatus 1. As such, during use fluid can flow through the plurality of hollow fibre membranes 4.

In the apparatus 1, the hydrophobic material of the plurality of hollow fibre membranes 4 provides the boundary between the second fluid passageway 10 and the third fluid passageways 11 within that second fluid passageway 10. Therefore, during use of the apparatus 1, a vapour or a gas is able to pass between the second fluid passageways 10 and the third fluid passageways 11. Thus, the apparatus can be used to separate a vaporous permeate from or combine a gas with a fluid that is within one of the at least one second fluid passageway 10 and the plurality of third fluid passageways 11. Several examples of different uses of the apparatus 1 is described below.

The apparatus 1 comprises a plurality of inlets 12, 13, 14 and outlets 15, 16, 17 for the fluid passageways 9, 10, 11 configured to permit fluid to enter and exit the respective fluid passageways. The apparatus 1 comprises inlets 12, 13, 14 for the first 9, second 10 and third 11 fluid passageways, respectively, at one end of the apparatus 1 and outlets 15, 16, 17 for the first 9, second 10 and third 11 fluid passageways, respectively, at the other end of the apparatus 1. As shown in FIG. 1, the inlet 12 and the outlet 15 for the first fluid passageway 9 are formed in the outer conduit 2. The inlet 13 and the outlet 16 of the plurality of second fluid passageways 10 and the inlet 14 and the outlet 17 of the plurality of third fluid passageways 11 are formed in the second cap 7.

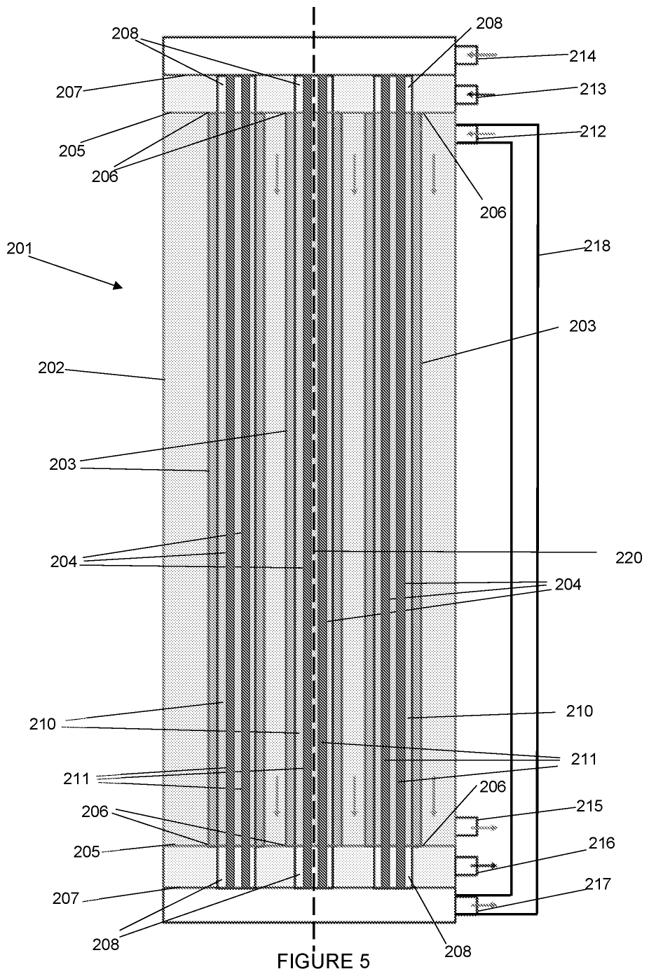

FIG. 4 shows an apparatus 101 according to another embodiment of the invention. The apparatus 101 is identical to the apparatus 1 of FIGS. 1 to 3 except that the apparatus 101 of FIG. 4 comprises an additional fluid passageway 118. Reference numerals in FIG. 4 correspond to those used in FIGS. 1 to 3 for like features but are transposed by 100.

As shown in FIG. 4, the apparatus 101 comprises a common fluid passageway 118 fluidly connecting the outlet 115 of the first fluid passageway 109 to the inlet 114 the plurality of third fluid passageways 111. As such, fluid exiting the first fluid passageway 109 may then enter the plurality of third fluid passageways 111 and be recirculated through the apparatus 101.

The common fluid passageway 118 comprises heating means 119 configured to heat fluid flowing along the common fluid passageway 118. The heating means 119 may comprise a heat exchanger or another suitable apparatus. Thus, fluid exiting the first fluid passageway 109 may be heated prior to entering the plurality of third fluid passageways 111.

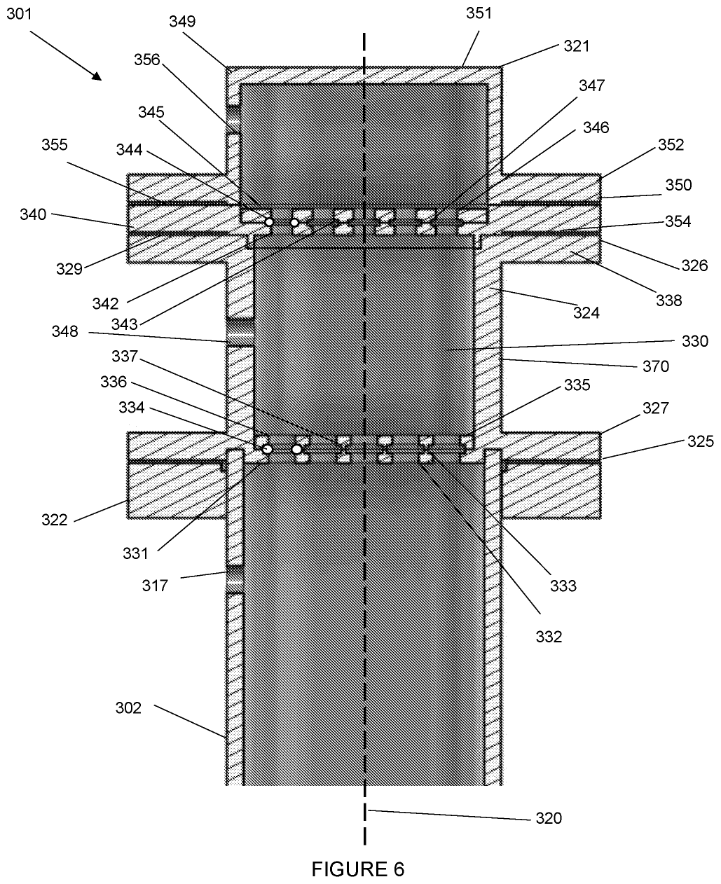

FIG. 5 shows an apparatus 201 according to another embodiment of the invention. The apparatus 201 is identical to the apparatus 1 of FIGS. 1 to 3 except that the apparatus 201 of FIG. 5 comprises an additional fluid passageway 218. Reference numerals in FIG. 5 correspond to those used in FIGS. 1 to 3 for like features but are transposed by 200.

In a similar manner to the embodiment shown in FIG. 4, the apparatus 201 comprises a common fluid passageway 218. However, in the embodiment of FIG. 5, the outlet 217 of each the plurality of third fluid passageways 211 is fluidly connected to the inlet 212 of the first fluid passageway 209 via the common fluid passageway 218. As such, fluid exiting the plurality of third fluid passageways 211 may enter the first fluid passageway 209 and be recirculated through the apparatus 201.

The common fluid passageway 218 may comprise recirculation means 219 for driving the recirculation fluid from the plurality of third fluid passageways 211 into the first fluid passageway 209 and for increasing the temperature and pressure of the fluid. The recirculation means 219 may comprise a vacuum pump, a fan or a compressor.

The apparatus of FIGS. 1 to 5 may be used in the following methods for the separation of or combination of fluids. The arrows shown in FIGS. 1, 2, 4 and 5 illustrate the direction of fluid flow within each apparatus during the different methods.

A method of fluid separation according to a first embodiment of the invention comprises providing an apparatus 1, 101 according to the embodiments shown in FIGS. 1 and 2 or in FIG. 4 and feeding a feed fluid through the plurality of third fluid passageways 11, 111. Feeding the feed fluid through the plurality of third fluid passageways 11, 111 may comprise feeding the feed fluid at a pressure that is less than the liquid entry pressure of the hydrophobic material of the plurality of the hollow fibre membranes 4, 104. The liquid entry pressure for the hollow fibre membranes 4, 104 is the pressure threshold which, when exceeded, the hydrophobic properties of the hollow fibre membranes 4, 104 are overcome. The liquid entry pressure may vary with the pore sizes of the hollow fibre membranes 4, 104, the number of hollow fibre membranes 1, 104 within each inner conduit 3, 103 and the diameters of the hollow fibre membranes 4, 104. In certain embodiments, the liquid entry pressure may be between 1 bar and 4 bar.

During the method, the vapour pressure in the plurality of third fluid passageways 11, 111 is greater than the vapour pressure in the plurality of second fluid passageways 10, 110 of the apparatuses 1, 101 of FIGS. 1, 2 and 4. This difference in vapor pressure drives a vaporous permeate of the feed fluid through the hydrophobic material of the plurality of hollow fibre membranes 4, 104 into the plurality of second fluid passageways 10, 110. The permeate is therefore separated from the feed fluid by membrane distillation. The difference in vapour pressure between the plurality of third fluid passageways 11, 111 and the plurality of second fluid passageways 10, 110 may be created by one of more of a temperature gradient, concentration gradient, applying a vacuum to the plurality of second fluid passageways or by another suitable method.

Once the permeate enters the plurality of second fluid passageways 10, 110, it is subsequently extracted from the plurality of second fluid passageways 10, 110. The permeate is extracted through the outlet 16, 116 of the plurality of second fluid passageways 10, 110.

The feed fluid may comprise any suitable liquid from which a vaporous permeate of a solvent may be extracted. For example, the feed fluid may comprise aqueous brine, such as seawater, and the vaporous permeate may comprise freshwater vapour. The method may therefore be used for the desalination of the brine.

In certain embodiments, the method may comprise feeding a coolant through the first fluid passageway 9, 109 where the temperature of the coolant is lower than the temperature of the feed fluid. The coolant may enable at least part of the permeate of the feed fluid to condense in the plurality of second fluid passageways 10, 110. The permeate may condense on the plurality of inner conduits 3, 103.

As the feed fluid passes through the plurality of third fluid passageways 11, 111 the feed fluid is cooled due to heat losses from evapouration of the permeate and through conduction. When the feed fluid exits the plurality of third passageways it may have cooled sufficiently to be used the coolant. As such, in certain embodiments, the feed fluid which exits the plurality of third fluid passageways 11, 111 may be recirculated as a coolant through the first fluid passageway 9, 109. In such embodiments, the outlet 17, 117 of the plurality of third fluid passageways 11, 111 may be fluidly connected to the inlet 12, 112 of first fluid passageway 9, 109.

When the method comprises providing the apparatus 100 of the embodiment shown in FIG. 4, the method may also comprise extracting the coolant from the first fluid passageway 109 and heating the extracted coolant to provide the feed fluid. The coolant may flow along the common fluid passageway 118 and be heated using the heating means 119 of the apparatus 100 in the embodiment shown in FIG. 4. Recirculating a single fluid for the coolant and the feed fluid enables it to be pre-heated by the latent heat of condensation of the vaporous permeate. Thus, the energy required by the method may be reduced.

The feed fluid may be recirculated through the first fluid passageway 9, 109 and the plurality of third fluid passageways 11, 111 until a desired amount of the vaporous permeate has been separated from the feed fluid.

Providing a coolant in the first fluid passageway 9, 109 creates a temperature gradient across each of the second fluid passageways 10, 110. In certain embodiments, this temperature gradient may create the difference in vapour pressure for driving the vaporous permeate of the feed fluid into the plurality of second fluid passageways 10, 110. In alternative embodiments, the coolant may predominately facilitate condensation of the vaporous permeate within the plurality of second fluid passageways 10, 110 and the difference in vapour pressure for driving the vaporous permeate of the feed fluid into the plurality of second fluid passageways 10, 110 may be provided at least in part by a concentration gradient or creating a vacuum in the plurality of second fluid passageways 10, 110.

In certain embodiments, the step of providing the apparatus 1, 101 may comprise providing air, a partial vacuum, a vacuum, a porous material or a liquid within the plurality of second fluid passageways 10, 110. Thus, the plurality of second fluid passageways 10, 110 may comprise (i.e. be filled with) air, a partial vacuum, a vacuum, a porous material or a liquid. The contents of the second fluid passageways 10, 110 may enable the method to utilise different techniques for membrane distillation.

In embodiments where the plurality of second fluid passageways 10, 110 comprise air, the method uses air gap membrane distillation. The vaporous permeate may pass through the air in the plurality of second fluid passageways 10, 110 and condense on the plurality of inner conduits 3, 103. The condensed permeate then flows downwards under gravity or by pumping towards the outlet 16, 116 of the plurality of second fluid passageways 10, 110. In such embodiments, the coolant may be fed into the first fluid passageway 9, 109 to provide vapour pressure difference to drive the membrane distillation and to enable condensation of the permeate.

In embodiments where the plurality of second fluid passageways 10, 110 comprise a partial vacuum or a vacuum, the method may use vacuum-assisted or vacuum membrane distillation, respectively. In such embodiments, the vacuum or partial vacuum increases the difference in vapour pressure for driving the vaporous permeate of the feed fluid through the plurality of hollow fibre membranes 4, 104 into the plurality of second fluid passageways 10, 110. This may be used as an alternative to the above-described temperature gradient provided by the coolant. The vacuum or partial vacuum causes the vaporous permeate to be drawn out of the apparatus 1, 101 at the outlet 16, 116 of the plurality of second fluid passageways 10, 110. The vaporous permeate may be condensed in a condenser which is separate to the apparatus 1, 101. Alternatively, the vaporous permeate may be condensed in the plurality of second fluid passageways 10, 110, for example, the vaporous permeate may condense on the plurality of inner conduits 3, 103.

In embodiments where the where the plurality of second fluid passageways 10, 110 comprise a porous material, the porous material may help to facilitate condensation of the vaporous permeate within the second fluid passageways 10, 110. Additionally, the porous material may reduce thermal losses from the plurality of third fluid passageways 11, 111 due to the coolant in the first fluid passageway 9, 109.

In embodiments where the plurality of second fluid passageways 10, 110 comprise a liquid, the method may use osmotic distillation. In such embodiments, the plurality of second fluid passageways 10, 110 comprise a liquid that has a lower concentration of a solvent than the feed fluid. The concentration gradient provides the difference in vapour pressure for driving the vaporous permeate of the feed fluid (i.e. the solvent) through the plurality of hollow fibre membranes 4, 104 into the plurality of second fluid passageways 10, 110. This may be used as an alternative to or in addition to the above-described temperature gradient provided by the coolant. The liquid enters the plurality of second fluid passageways 10, 110 through the inlet 13, 113 of the plurality of second fluid passageways 10, 110 and exits together with the permeate through the outlet 16, 116 of the plurality of second fluid passageways 10, 110.

Alternatively, the method may use sweep gas membrane distillation. Non-limiting examples of the sweep gas include air and nitrogen. In such embodiments, the step of extracting the permeate of the feed fluid from the plurality of second fluid passageways 10, 110 comprises feeding a sweep gas through the plurality of second fluid passageways 10, 110. The sweep gas enters the plurality of second fluid passageways 10, 110 through the inlet 13, 113 of the plurality of second fluid passageways 10, 110. The vaporous permeate is removed from the apparatus 1, 101 together with the sweep gas at the outlet 16, 216 of the plurality of second fluid passageways 10, 110. The vaporous permeate may then be condensed in a condenser which is separate to the apparatus 1, 101. In such embodiments, the coolant may be fed into the first fluid passageway 9, 109 to provide the difference in vapour pressure for driving the vaporous permeate of the feed fluid into the plurality of second fluid passageways 10, 110

A method of fluid separation according to a second embodiment of the invention comprises providing an apparatus 1, 201 according to the embodiments shown in FIGS. 1 and 2 or in FIG. 5 and feeding a feed fluid through the plurality of second fluid passageways 10, 210. Feeding the feed fluid through the plurality of second fluid passageways 10, 210 may comprise feeding the feed fluid at a pressure that is less than the liquid entry pressure of the hydrophobic material of the plurality of the hollow fibre membranes 4, 204.

During the method, the vapour pressure in the plurality of second fluid passageways 10, 210 is greater than the vapour pressure in the plurality of third fluid passageways 11, 211 of the apparatuses 1, 201 of FIGS. 1, 2 and 4. As described above in the method of the first embodiment, this difference in vapor pressure drives a vaporous permeate of the feed fluid through the hydrophobic material of the plurality of hollow fibre membranes 4, 204 into the plurality of third fluid passageways 11, 211. The permeate is therefore separated from the feed fluid by membrane distillation. The difference in vapor pressure between the plurality of third fluid passageways 11, 211 and the plurality of second fluid passageways 10, 210 may be created by one of more of a temperature gradient, concentration gradient, applying a vacuum to the plurality of second fluid passageways or by another suitable method.

Once the permeate enters the plurality of third fluid passageways 11, 211, it is extracted from the plurality of third fluid passageways 11, 211. The permeate is extracted through the outlet 17, 217 of the plurality of third fluid passageways 11, 211.

When the method comprises providing the apparatus 200 of the embodiment shown in FIG. 5, the vaporous permeate extracted from the plurality of third fluid passageways 11, 211 may be recirculated through the apparatus 200 via the common fluid passageway 218. In such embodiments, the permeate is extracted from the plurality of third fluid passageways 11, 211 by the recirculation means 219 which increases the temperature and pressure of the permeate. The permeate is then fed into the first fluid passageway 9, 209. In the first fluid passageway 9, 209, the permeate condenses on the inner 3, 203 transferring the latent heat of condensation to the feed fluid in the plurality of second fluid passageways 10, 210. Thus, reducing the energy required by the method.

In the same manner as the method of the first embodiment, the feed fluid may comprise any suitable liquid from which a vaporous permeate of a solvent may be extracted. During the method, the feed fluid may be recirculated through the apparatus 1, 201. That is, once the feed fluid has passed through the outlet 16, 216 of the plurality of second fluid passageways 10, 210 it may be directed back into the inlet 13, 213 of the plurality of second fluid passageways 10, 210.

In certain embodiments, the step of providing the apparatus 1, 201 may comprise providing a partial vacuum, a vacuum or a liquid within the plurality of the plurality of third fluid passageways 11, 211. Thus, the plurality of third fluid passageways 11, 211 may comprise a partial vacuum, a vacuum or a liquid. The contents of the plurality of third fluid passageways 11, 211 may enable the method to utilise different techniques for membrane distillation.

In embodiments where the plurality of second fluid passageways 10, 210 comprise a partial vacuum or a vacuum, the method may use vacuum-assisted or vacuum membrane distillation, respectively. The vacuum or partial vacuum increases the difference in vapour pressure for driving the vaporous permeate of the feed fluid through the plurality of hollow fibre membranes 4, 204 into the plurality of second fluid passageways 10, 210. The vaporous permeate may then be recirculated through the apparatus 1, 201 by removing it from the plurality of third fluid passageways 11, 211 using a vacuum pump or a compressor 219 to increase its temperature and pressure and feeding the permeate into the first fluid passageway 9, 209 to condense.

Alternatively, the method may use sweep gas membrane distillation. Non-limiting examples of the sweep gas include air and nitrogen. In such embodiments, the step of extracting the permeate of the feed fluid from the plurality of third fluid passageways 11, 211 comprises feeding a sweep gas through the plurality of third fluid passageways 11, 211. The sweep gas enters the plurality of third fluid passageways 11, 211 through the inlet 14, 214 of the plurality of third fluid passageways 11, 211. The vaporous permeate is removed from the apparatus 1, 201 together with the sweep gas at the outlet 17, 217 the plurality of third fluid passageways 11, 211. The vaporous permeate and sweep gas may then be recirculated through the apparatus 1, 201. The vaporous permeate and sweep gas may be removed from the plurality of third fluid passageways 11, 211 using a fan or a compressor 219 which increases its temperature and pressure and fed into the first fluid passageway 9, 209 where the permeate condenses.

In the methods according to the first and second embodiments of the invention, the feed and permeate may flow along the fluid passageways in the apparatus 1, 101, 201 at a rate from 0.5 to 10 litres per minutes and at a pressure of from 1 to 10 bar. However, the flow rates and pressures are not limited to these ranges. For example, the apparatus 1, 101, 201 could be used for high pressure filtration which exceeds 30 bar. Exemplary flow rates through the hollow membrane fibres 4, 104, 204 are from 1 to 40 litres per square meter per hour and will vary depending on the temperature of the feed fluid, the flow rate, heat recovery and the chemistry of the feed fluid. Typically, the temperature of the feed fluid entering the apparatus 1, 101, 201 is in the range from 30 to 90° C.

The apparatus 1 may be used to perform a method for combining a gas with a liquid according to a third embodiment of the invention. That is, the apparatus may be used as a gas contactor. The method comprises providing the apparatus 1 of the embodiment shown in FIGS. 1 to 3 and feeding a feed liquid through the plurality of second fluid passageways 10. A gas for combining with the feed liquid is fed through the plurality of third fluid passageways 11. As the gas flows through the plurality of third fluid passageways 11, it permeates through the hollow fibre membranes 4 and enters the feed liquid.

The method may be performed to combine any suitable feed liquid and gas. For example, the feed liquid may comprise an aqueous brine and the gas may comprise CO₂ or flue gas. When combining aqueous brines with CO₂ or flue gas the reaction between the gas and liquid may form carbonate minerals such as CaCO₃ or MgCO₃. As such, the method may be used for carbon sequestration. Other examples for a gas for combining with the feed liquid include SO₂, NO or H₂S. The method may also be used for the carbonation of beverages.

The method may comprise applying pressure to drive the gas through the plurality of the hollow fibre membranes 4. The pressure may be applied to the gas such that the gas is pushed through the hollow fibre membranes 4 to combine with the feed liquid. A pump, pressurised vessel with a pressure regulator or other suitable means may be used to apply pressure to the gas.

The method may comprise regulating the temperature in the plurality of second fluid passageways 10 by feeding a regulating fluid through the first fluid passageway 9. For example, the temperature of the regulating fluid may be greater that the temperature of the feed liquid. Thus, the regulating fluid transfers heat to the feed liquid increasing the temperature of the feed liquid which may result in faster reaction kinetics, improving the combination of the gas with the liquid.

The method if not limited to feeding the feed liquid through the plurality of second fluid passageways 10 and the gas through the plurality of third fluid passageways 11. Alternatively, the feed liquid may be fed through plurality of third fluid passageways 11 and the gas may be fed through the plurality of second fluid passageways 10.

The above-described apparatus and methods enable the separation or combination of fluids. Including a plurality of hollow fibre membranes within each inner conduit of the apparatus provides a large surface area through which a permeate or gas may pass. Providing three different fluid passageways within the apparatus enable temperature regulation of fluids in the apparatus and facilitates condensation of a permeate within the apparatus. The apparatuses and methods may therefore improve the efficiency of and reduce the energy required for separating a permeate from a fluid or combining of a gas with a liquid. Including a plurality of inner conduits within the outer conduit further improve these efficiencies and reduce the energy requirements.

In any of the embodiments shown in FIGS. 1 to 5, the size of the outer conduit, inner conduit and plurality of hollow fibre membranes may be selected depending on the intended use of the apparatus.

The diameter of the outer conduit 2 may be relatively large compared to that of the inner conduits 3 in order to reduce heat loss from the outer surface of the outer conduit. In certain embodiments, the outer conduit 2 may have a diameter of approximately 110 mm. Each of the inner conduits 3 may have an outer diameter of approximately 15 mm. As shown in the embodiment of FIG. 2, the outer diameter of all inner conduits 3 in the apparatus may be the same as each other.

The outside diameter of the hollow fibre membranes may be 0.3 mm or greater or the outside diameter of the hollow fibre membranes may be from 0.3 mm to 3 mm. As described above, during use of the apparatus a fluid may flow through the plurality of third fluid passageways 11 (i.e. through the plurality of hollow fibre membranes 4). The smaller the diameter of the hollow fibre membranes 4, the larger the drop in pressure across the length of the membrane 4 that is required for fluid to flow through the membrane 4. Thus, the diameter of the hollow fibre membranes 4 will depend on the intended use of the apparatus 1. Hollow fibre membranes having an outside diameter of 1 mm and an inside diameter of 0.9 mm (i.e. a wall thickness of 0.05 mm) may provide sufficient surface area for the membrane whilst minimising the pressure drop.

The plurality of hollow fibre membranes 4 may have a length from 0.3 m to 4 m. The inner 3 and outer 2 conduits may have a length from 0.3 m to 4 m. The drop in pressure along the hollow fibre membranes 4 increases with the length of the membrane 4. Thus, the length of the hollow fibre membranes 4 will depend on the intended use of the apparatus 1. A hollow fibre membrane 4 length of 1 m may allow sufficient vapour flow through the membrane and an acceptable pressure drop along the membrane.

The volume of each inner conduit 3 which is occupied by the plurality of hollow fibre membranes 4 is selected based on the intended use of the apparatus 1. The packing density of the hollow fibre membranes 4 within each inner conduit 3 provides a measure of the amount of the inner conduit 3 which is filled by the hollow fibre membranes 4. The packing density is the ratio of the surface area of the plurality of hollow fibre membranes 4 to the volume of the inner conduit 3 in which they are contained. As described above, during use of the apparatus a fluid may flow through the plurality of third fluid passageways 11 (i.e. through the plurality of hollow fibre membranes 4) and/or through the plurality of second fluid passageways 10. If the packing density of the hollow fibre membranes 4 is high, for example greater than 20,000 m²/m³ it may result in laminar flow rather than turbulent flow of the fluid. Turbulent flow improves heat transfer through the apparatus 1 whereas laminar flow may reduce heat transfer through the apparatus 1. Furthermore, if the packing density is high a greater pressure is required to drive the fluid along the plurality of second 10 or third fluid passageways 111 through the apparatus. As such, the packing density of the hollow fibre membranes within each inner conduit may be less than 20,000 m²/m³ or less than 10,000 m²/m³.

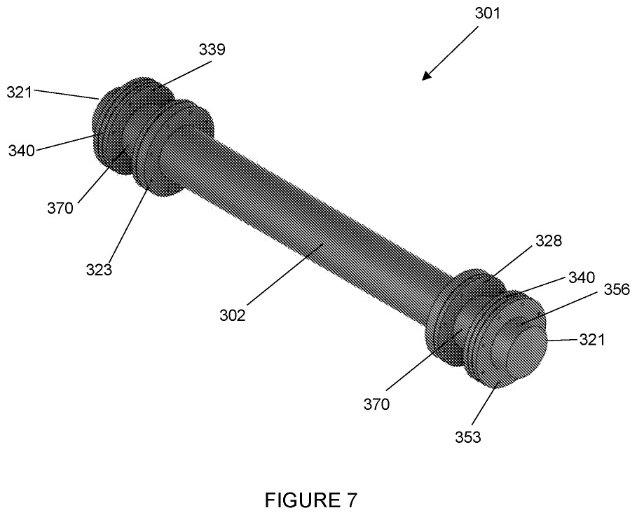

FIGS. 6 and 7 shows an apparatus 301 according to another embodiment of the invention. The apparatus 301 is substantially the same as the apparatus 1 of FIGS. 1 to 3 except in how the outer and inner conduits are fluidly sealed. That is, the apparatus 301 of FIGS. 6 and 7 comprises first collar 370, second collar 340 and cap 321 which differ from the first and second caps 5, 7 described for the apparatus 1 in the embodiment of FIGS. 1 to 3. The apparatus 301 may be used in either of the embodiments shown in FIGS. 4 and 5. Thus, the apparatus 301 may be used in combination with either of the common fluid passageways 118, 218. Reference numerals in FIGS. 6 and 7 correspond to those used in FIGS. 1 to 3 for like features but are transposed by 300. The apparatus 301 may be used in any of the above-described methods.

As shown in FIG. 6, the apparatus 301 comprises an outer conduit 302. The outer conduit 302 may comprise a two openings 317 to allow fluid to enter and exit the first fluid passageway. The openings 317 may be in the side walls of the outer conduit 302. The outer conduit 302 may include all features of the outer conduit 2 described in reference to the apparatus 1 in FIGS. 1 to 3. The outer conduit 302 may additionally comprise a flange 322 positioned at each end of the outer conduit 302. Each flange 322 may surround one end of the outer conduit 302. The flange 322 may comprise a plurality of holes 323 extending therethrough. The holes 323 may be configured to receive fasteners (not shown), such as a threaded fastener like a bolt or a screw. The bolt may be configured to receive a nut.

Whilst not shown, the apparatus 301 is configured to receive a plurality of inner conduits and a plurality of hollow fibre membranes within each of the inner conduits. The apparatus 301 is configured to receive inner conduits and hollow fibre membranes that are substantially the same and arranged in the same manner as those described in reference to the apparatus in FIGS. 1 to 3. Thus, the apparatus 301 may provide: a first fluid passageway provided between the outer conduit 302 and the plurality of inner conduits; a plurality of second fluid passageways provided between each of the inner conduits and the plurality of hollow fibre membranes within that conduit; and a plurality of third fluid passageways, each of the third fluid passageways being within one of hollow fibre membranes the apparatus 301 is configured to receive.

As shown in FIGS. 6 and 7, the apparatus 301 comprises at least one first collar 370. The first collar 370 may be configured to be secured to an end of the outer conduit 302. As shown in FIG. 7, the apparatus 301 may comprise two first collars 370, each first collar 370 being securable to one end of the outer conduit 302.

The first collar 370 may comprise a body 324 extending from a first end 325 to a second end 326. The first collar 370 may comprise a first flange 327 to facilitate securing of the first collar 370 to the outer conduit 302. The first flange 327 may be positioned at the first end 325 of the body 324. The first flange 327 and the body 324 may be formed as one piece or the first flange 327 may be secured to the body 324. The first flange 327 may comprise a plurality of holes 328 arranged to align with the holes 323 in one of the flanges 322 of the outer conduit 302. The holes 322 in the first flange 327 may also be configured to receive fasteners (not shown). Thus, the first collar 370 may be secured to the outer conduit 302 by aligning the holes 323 in the flange 322 of the outer conduit 302 and the holes 328 in the first flange 327 then inserting the fasteners through the holes 323, 328.

The apparatus 301 may comprise a first gasket 329 arranged between the flange 322 of the outer conduit 302 and the first flange 327 of the first collar 370. The first gasket 329 may fluidly seal the outer conduit 302 to the first collar 370.

As shown in FIG. 6, the body 324 of the first collar 370 comprises a passage 330 extending therethrough so that the inner conduits may extend into the first collar 370 from the outer conduit 302. As such, the first collar 370 may have a substantially hollow interior. The passage 330 through the first collar 370 may be substantially cylindrical. The passage 330 may have a diameter less than or equal to an internal diameter of the outer conduit 302.

The first collar 370 may comprise a fixed insert 331 which extends across the passage 330 of the first collar 370. The fixed insert 331 may be positioned at or towards the first end 325 of the first collar 370. The fixed insert 331 is in a fixed in position relative to the body 324 of the first collar 370.

The fixed insert 331 comprises a plurality of apertures 332. Each aperture 332 is configured to receive one of the inner conduits. As such, the inner conduits may extend from the outer conduit 302 into the first collar 370. The diameter of each aperture 332 in the fixed insert 331 may be the same as or larger than an outer diameter of the inner conduits. The fixed insert 331 comprises the same number of apertures 332 as the number of inner conduits the outer conduit 302 is configured to receive.

The fixed insert 331 may comprise a groove 333 extending circumferentially around each aperture 332 on one side of the insert 331. The grooves 333 may be positioned on the side of the fixed insert 331 facing towards the second end 326 of the body 324. The first collar 370 may comprise a plurality of first o-rings 334. The grooves 333 are configured to partially receive one of the plurality of first o-rings 334. The first o-rings 334 may comprise an elastomeric material. In FIG. 6, for simplicity only one of the grooves 333 is shown as having a first o-ring 334 residing therein. However, all grooves 333 are configured to receive a first o-ring 334.

The apparatus 301 may comprise a first removable insert 335. The first removable insert 335 is releasably securable to the body 324 of the first collar 370. The first removable insert 335 may be configured to extend across the passage 330 of the first collar 370. Thus, the first removable insert 335 may have the same diameter as the diameter of the passage 330 of the first collar 370.

The first removable insert 335 may comprise a plurality of apertures 336. The apertures 336 in the first removable insert 335 correspond to the apertures 332 in the fixed insert 331. That is, apertures 336 in the first removable insert 335 have the same shape, size and distribution as the apertures 332 in the fixed insert 331. Thus, each aperture 336 in the first removable insert 335 is configured to receive one of the inner conduits.

The first removable insert 335 may comprise a groove 337 extending circumferentially around the of each aperture 336 on one side of the insert 334. In the same manner as the fixed insert 331, the grooves 337 in the first removable insert 335 may be configured to partially receive one of the plurality of first o-rings 334.

The fixed insert 331 and the first removable insert 335 comprise a plurality of holes (not shown) configured to receive fasteners (not shown). Non-limiting examples of the fasteners include as a threaded fastener such as a bolt or a screw. The bolt may be configured to receive a nut. The holes may be positioned between the apertures 332, 336 in each of the inserts 331, 335. The holes in the fixed insert 331 and first removable insert 335 are arranged so that the inserts 331, 335 may be secured together by the fasteners. FIG. 6 shows the fixed insert 331 secured to the first removable insert 335. The first removable insert 335 may be secured to the fixed insert 331 so that the grooves 337 surrounding the apertures 336 in the first removable insert 335 are next to with the grooves 333 surrounding the apertures 332 in the fixed insert 331. As such, each of the first o-rings 334 may reside between within the grooves 333, 337 between the two inserts 331, 335. The axial height of the first o-rings is greater than the combined axial height of the grooves 333, 337 in the fixed and first removable inserts 331, 335. The height of the first o-rings 334 and the grooves 333, 337 is in a direction parallel to the longitudinal axis 320 shown in FIG. 6.

The fixed and first removable inserts 331, 335 are configured so that as the inserts 331, 335 are secured together the first o-rings 334 are compressed axially. This results in radial expansion of the first o-rings 334. As such, when the inserts 331, 335 are secured together the first o-rings 334 form a fluid tight seal around inner conduits that extend through the apertures 332, 336. Therefore, fluid within the first fluid passageway, between the outer conduit 302 and the plurality of inner conduits, is prevented from passing through the first collar 370. The first collar 370 may therefore fluidly seal the ends of the outer conduit 302.

At the second end 326 of the body 324, the first collar 370 may comprise a second flange 338. In the same manner as the first flange 327 of the first collar 370, the second flange 338 comprises a plurality of holes 339 configured to receive fasteners. The second flange 338 and the body 324 may be formed as one piece or the second flange 338 may be secured to the body 324.

As shown in FIG. 6, the apparatus 301 may comprise at least one second collar 340. As shown in FIG. 7, the apparatus 301 may comprise two second collars 340, each second collar 340 being securable one of the first collars 370. The second collar 340 is configured to be secured to the second flange 338 of the first collar 370. As such, the second collar 340 may comprise a plurality of holes (not shown) which correspond to the holes 339 in the second flange 338 of the first collar 324 so that the second collar 340 and the second flange 338 may be secured together by a plurality of fasteners (not shown), such as a threaded fastener like a bolt or a screw. The bolt may be configured to receive a nut.

The second collar 340 is arranged to cover the passage 330 in the first collar 324. The second collar 340 comprises a plurality of apertures 342. As described above, a plurality of hollow fibre membranes is within each of the inner conduits. Each aperture 342 in the second collar 340 is configured to receive the plurality of hollow fibre membranes from one of the inner conduits. As such, plurality of hollow fibre membranes extend from the first collar 370 through the second collar 340. However, the inner conduits do not pass through the second collar 340. The apertures 342 in the second collar 340 may have a smaller diameter that the outer diameter of the inner conduits. When the apparatus 301 is assembled, the inner conduits pass through the apertures 332, 336 in the fixed and first removable inserts 331, 335 of first collar 370 into the passage 330 in the first collar 370. The inner conduits end within the first collar 370. The plurality of hollow fibre membranes extend from the end of their respective inner conduit and pass through the second collar 340.

Each of the plurality of inner conduits comprises a plurality of hollow fibre membranes disposed therein. Thus, each of the plurality of inner conduits comprises a bundle of hollow fibre membranes. The plurality of hollow fibre membranes in each bundle may be secured together by a support (not shown). The support may hold the plurality of hollow fibre membranes in each bundle in a fixed position relative to one another.

The support may comprise a solid cylinder having a plurality of apertures through which the plurality of hollow fibre membranes extend. The support may comprise a potting material to fixedly hold the plurality of hollow fibre membranes relative to one another. Alternatively, the hollow fibre membranes may be secured within the apertures by a potting material. The potting materials may comprise any suitable material for fixing the plurality of hollow fibre membranes in place. Suitable potting materials include but are not limited to epoxy, polyurethane and silicone adhesives.

The support may be positioned on the plurality of hollow fibre membranes so that the support resides in the apertures 342 of the second collar 340 when the plurality of hollow fibre membranes are positioned within the inner conduits in the apparatus 301. Thus, the diameter of the apertures 342 in the second collar 340 may be the same as or larger than the outer diameter of the support.

The second collar 340 may comprise a groove 343 extending circumferentially around each aperture 342 on one side of the second collar 340. The apparatus 301 may comprise a plurality of second o-rings 344. In a similar manner to the fixed and first removable inserts 331, 335 of the first collar 324, the grooves 343 in the second collar 340 are configured to partially receive one of the plurality of second o-rings 344. The second o-rings 344 may comprise an elastomeric material. In FIG. 6, for simplicity only one of the grooves 343 is shown as comprising a second o-ring 344. However, all grooves 343 are configured to receive a second o-ring 344.

The apparatus 301 may comprise a second removable insert 345. The second removable insert 345 is releasably securable to the second collar 340. The second removable insert 345 may be arranged to cover the passage 330 in the first collar 370. The second removable insert 345 comprises a plurality of apertures 346. Each aperture 346 is configured to receive the plurality of hollow fibre membranes from one of the inner conduits. In particular, the apertures 346 in the second removable insert 345 are configured to receive the support of the plurality of hollow fibre membranes from one of the inner conduits. The apertures 346 in the second removable insert 345 correspond to the apertures 342 in the second collar 340. That is, apertures 346 in the second removable insert 345 have the same shape, size and distribution as the apertures 342 in the second collar 340.

The second removable insert 345 may comprise a groove 347 extending circumferentially around the of each aperture 346 on one side of the insert 345. In the same manner as the second collar 340, the grooves 347 in the second removable insert 345 are configured to receive one of the plurality of second o-rings 344.

The second collar 340 and second removable insert 345 comprise a plurality of holes (not shown) configured to receive fasteners (not shown). Non-limiting examples of the fasteners include as a threaded fastener such as a bolt or a screw. The holes may be positioned between the apertures 342, 346 in each of the second collar 340 and the insert 345. The holes in the second collar 340 and the second removable insert 345 are arranged so that the second collar 340 and the insert 345 may be secured together by fasteners. FIG. 6 shows the second removable insert 345 secured to the second collar 340. The second removable insert 345 is secured to the second collar 340 so that the grooves 347 surrounding the apertures 346 in the second removable insert 345 are next to with the grooves 343 surrounding the apertures 342 in the second collar 340. As such, each second o-ring 344 may reside between within the grooves 343, 347 between the second collar 340 and the second removable insert 345. The axial height of the second o-rings 344 is greater than the combined axial height of the grooves 342, 346 in the second collar 340 and second removable insert 345. The height of the second o-rings 344 and the grooves 342, 346 is in a direction parallel to the longitudinal axis 320 shown in FIG. 6.

The second collar 340 and second removable insert 345 are configured so that when they are secured together the plurality of o-rings second 344 are compressed axially. This results in radial expansion of the second o-rings 344. As such, the second o-rings 344 provide a fluid tight seal around support of each of the plurality of hollow fibre membranes that extend through the apertures 342, 346. Therefore, fluid within the second fluid passageways, between each of the inner conduits and the plurality of hollow fibre membranes within the conduit, is prevented from passing through the second collar 340. The second collar 340 may therefore fluidly seal the ends of the inner conduits. The first collar 370 may comprise an opening 348 to allow fluid to enter and exit the second fluid passageways. As shown in FIG. 6, the opening 348 may be in a side wall of the first collar 370.

As shown in FIGS. 6 and 7, the apparatus 301 may comprise at least one cap 321. As shown in FIG. 7, the apparatus 301 may comprise two caps 321, each cap 321 being securable one of the second collars 340. The cap 321 may comprise body 349 having first open end 350 and a second closed end 351.

The cap 321 is configured to be secured to the second collar 340. The cap 321 may comprise flange 352 to secure the cap 321 to the second collar 340. The flange 352 may be at the first end 350 of the cap 321. The flange 352 of the cap 321 may comprise a plurality of holes 353 which correspond to those in the second collar 340 and in the second flange 338 of the first collar 370 so that the cap 321, the second collar 340 and the first collar 370 may be secured together as shown in FIG. 7. The cap 321, the second collar 340 and the second flange 338 of the first collar 370 may be secured together by a plurality of fasteners (not shown). The fasteners may comprise threaded fasteners, such as a bolt or a screw. The bolt may be configured to receive a nut. In alternative embodiments, cap 321, the second collar 340 and the first collar 370 may be configured such that cap 321 and the second collar 340 are secured to each other by one set of fasteners and the first collar 370 and the second collar 340 are secured to each other by a different set of fasteners.

The apparatus 301 may comprise a second and a third gasket 354, 355. The second gasket 354 maybe arranged between the second flange 338 of the first collar 370 and the second collar 340. The third gasket 355 may be arranged between the second collar 340 and the flange 352 of the cap 321. The second and third gaskets 354, 355 may fluidly seal the first collar 370 to the second collar 340 and the second collar 340 to the cap 321, respectively.

The cap 321 is configured to receive the plurality of hollow fibre membranes. That is, when the hollow fibre membranes are within the apparatus 301, they extend through the first collar 370 and through the second collar 340 into the cap 321. Thus, fluid may pass between interior of the cap 321 and third fluid passageways within the hollow fibre membranes. However, the first and second plurality of o-rings 334, 344 fluidly seal the inner conduits and the outer conduit 302 from the cap 321. Thus, the cap 321 is fluidly isolated from the first fluid passageway and the second fluid passageways. The cap 321 may comprise an opening 356 to allow fluid to enter and exit the third fluid passageways. As shown in FIG. 6, the opening 356 may be formed in a side wall of the cap 321.

Whilst FIG. 6 shows one end of the apparatus 301, each of end of the apparatus 301 may be identical as shown in FIG. 7. That is, each end of the apparatus 301 may comprise an first collar 370, a second collar 340 and an cap 321.

To assemble the apparatus 301 of FIGS. 6 and 7, a plurality of hollow fibre membranes are placed within each inner conduit. The support may be provided either before or after the hollow fibre membranes are placed in the inner conduits. The inner conduits enclosing the plurality of hollow fibre membranes are then placed within the outer conduit 302. The inner conduits are configured to extend out of each end of the outer conduit 302 and the hollow fibre membranes are configured to extend out of each end of their inner conduits.

A removable jig may be used to keep the inner conduits and hollow fibre membranes in the correct position at one of the outer conduit 302 whilst the first collar 370, the second collar 340 and the cap 321 are attached to the other end of the outer conduit 302.

To secure the first collar 370 to the outer conduit 302, the first collar 370 is placed over the inner conduits so that the inner conduits extend through the apertures 332 in the fixed insert 331 of the first collar 370. The first collar 370 may be secured to the outer conduit 302 via fasteners extending through the holes 323, 328 in the first flange 327 of the first collar 370 and the flange 322 of the outer conduit 302. The plurality of first o-rings 334 may be located into the grooves 333 in the fixed insert 331 of the first collar 321.

The first removable insert 335 may then be placed onto the inner conduits and secured to the fixed insert 331 of the first collar 321. As the first removable insert 335 is secured to the fixed insert 331, the plurality of first o-rings 334 are compressed between the inserts 331, 335 to provide a fluid tight seal around the inner conduits.

The second collar 340 may then be placed on the first collar 370 so that the plurality of hollow fibre membranes extend through the apertures 342 in the second collar 340. The second collar 340 may be positioned so that the supports on the plurality of hollow fibre membranes reside within the apertures 342 in the second collar 340. The plurality of second o-rings 344 may be located into the grooves 343 in the second collar 340.

The second removable insert 345 may then be placed over the plurality of hollow fibre membranes so that the membranes extend through the apertures 346 in the second removable insert 345. The second removable insert 345 may be secured to the second collar 340 causing the second plurality of o-rings 344 to be compressed between the insert 345 and the second collar 340 thereby providing a fluid tight seal around the supports and the hollow fibre membranes.

The end cap 321 may then be located on the second collar 340. The end cap 321, second collar 340 and first collar 370 may then be secured together. Thus, the first collar 370, cap 321 and the second collar 340 are secured to one end of the outer conduit. The removable jig may then be removed from the other end of the outer conduit 302 and the process may be repeated.

The features of the apparatus 301 shown in FIGS. 6 and 7, may improve ease of assembly and dismantling of the apparatus 301 compared to, for example, an apparatus in which the membranes and/or inner conduits are secured within the apparatus by welding or an adhesive. This may enable greater ease of replacing the membranes in the apparatus and cleaning the apparatus. As such, the entirety of the apparatus 301 does not need to be replaced when the membranes need replacing.

The skilled person would understand that various modifications can be made to the above described embodiments.

In the above described embodiments, the apparatus comprises a plurality of inner conduits. In alternative embodiments, the apparatus may comprise a single inner conduit and a single second fluid passageway. The method of the first, second and third embodiment may also comprise proving an apparatus comparing a single inner conduit and a single second fluid passageway.

In the apparatus shown in the Figures, there is one inlet and one outlet of all the plurality of second fluid passageways and one inlet and one outlet for all of the plurality of third fluid passageways. In alternative embodiments, there may be a different number of inlets and outlets. For example, each of the second and/or third fluid passageways may have an individual inlet and an individual outlet.

In certain embodiments, more than one apparatus may be provided in each of the above described methods. For example, the methods may comprise a plurality of apparatuses as shown in the embodiments of FIGS. 1 to 7 connected together in series or in parallel. When a plurality of membrane distillation apparatuses of the embodiment shown in FIG. 1 are connected in series, the apparatuses may be connected such that the mineral-rich solution is recirculated through all the apparatuses. For example, the outlet of the plurality of third fluid passageways of the last apparatus in the series may be fluidly connected to the inlet of the first fluid passageway of the first apparatus in the series. As such, the mineral-rich solution may flow through the plurality of third fluid passageways of each apparatus in the series before being recirculated as a coolant through the first fluid passageway of each apparatus in the series. Additionally or alternatively, the outlet of the first fluid passageway of the last apparatus in the series may be fluidly connected to the inlet of the plurality of first fluid passageways in the series. As such, the coolant may flow through the first fluid passageway of each apparatus in the series before being recirculated as the mineral-rich solution through the plurality of third fluid passageways of each apparatus in the series. The coolant may be heated prior to being recirculated as the mineral-rich solution. The mineral-rich solution may be recirculated through the series of apparatuses until the concentration of the mineral in the mineral-rich solution has reached a desired concentration.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An apparatus for the separation or combination of fluids comprising:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which vapour and/or gas is passable such that, during use, a vaporous permeate is separable from or a gas is combinable with a fluid that is within one of the at least one second fluid passageway and the plurality of third fluid passageways; and
wherein the at least one inner conduit comprises a plurality of inner conduits.

2. An apparatus according to claim 1, wherein the outer conduit and/or the at least one inner conduit comprises an impermeable material, or wherein the at least one the inner conduit comprises a thermally conductive material.

3. (canceled)

4. An apparatus according to claim 1, comprising a common fluid passageway fluidly connecting an outlet of the first fluid passageway to an inlet the plurality of third fluid passageways, optionally wherein the common fluid passageway comprises heating means configured to heat fluid in the common fluid passageway.

5. (canceled)

6. An apparatus according to claim 1, comprising a common fluid passageway fluidly connecting an outlet of the plurality of third fluid passageways to an inlet of the first fluid passageway, optionally wherein the common fluid passageway comprises a vacuum pump, a fan or a compressor.

7. (canceled)

8. An apparatus according to claim 1 comprising:
a first collar securable to an end of the outer conduit;
a first insert releasably securable to the first collar; and
a plurality of first o-rings arranged between the first collar and the first insert;
wherein each of the first collar and the first insert comprise a plurality of apertures and the plurality of inner conduits extend through the first collar and the first insert via the apertures;
wherein one of the first o-ring surrounds each of the inner conduits; and
wherein the first insert is securable to the first collar such that each of the first o-rings are compressed to sealing engage one of the inner conduits, optionally wherein each of the first collar and the first insert comprise a groove extending circumferentially around each aperture, the grooves being configured to receive the first o-rings between the first collar and the first insert; and
wherein the height of the first o-rings is greater than the combined height of the grooves in the first insert and the first collar, or optionally wherein the first insert is releasably securable to the first collar by at least one threaded fastener.

9. (canceled)

10. (canceled)

11. An apparatus according to claim 8, wherein each of the plurality of inner conduits comprises a bundle of hollow fibre membranes disposed therein and each bundle comprises a support configured to secure the hollow fibre membranes together, optionally wherein the support comprises a potting material.

12. (canceled)

13. An apparatus according to claim 11, comprising:
a second collar securable to the first collar;
a second insert releasably securable to the second collar; and
a plurality of second o-rings arranged between the second collar and the second insert;
wherein each of the second collar and the second insert comprise a plurality of apertures, each aperture being configured to receive one of the supports so that the plurality of hollow fibre membranes extend through the second collar and the second insert;
wherein one of the second o-rings surrounds each of the supports; and
wherein the second insert is securable to the second collar such that each of the second o-rings are compressed to sealing engage supports, optionally wherein each of the second collar and the second insert comprise a groove extending circumferentially around the each aperture, the grooves being configured to receive the second o-rings between the second collar and the second insert; and
wherein the height of the second o-rings is greater than the combined height of the grooves in the second insert and the second collar, or optionally wherein the second insert is releasably securable to the second collar by at least one threaded fastener.

14. (canceled)

15. (canceled)

16. A method of fluid separation comprising:
providing the apparatus of claim 1;
feeding a feed fluid through the plurality of third fluid passageways; and
extracting a permeate of the feed fluid from the at least one second fluid passageway;
wherein the vapour pressure in the plurality of third fluid passageways is greater than the vapour pressure in the at least one second fluid passageway.

17. A method according to claim 16, comprising feeding a coolant through the first fluid passageway to condense at least part of the permeate of the feed fluid in the at least one second fluid passageway;
wherein the temperature of the coolant is lower than the temperature of the feed fluid.

18. A method according to claim 17, comprising extracting the coolant from the first fluid passageway and heating the extracted coolant to provide the feed fluid.

19. A method according to claim 16, wherein the at least one second fluid passageway comprises air, a partial vacuum, a vacuum, a porous material or a liquid, or wherein extracting the permeate of the feed fluid from the at least one second fluid passageway comprises feeding a sweep gas through the at least one second fluid passageway.

20. (canceled)

21. A method according to claim 16, wherein feeding the feed fluid through the plurality of third fluid passageways comprises feeding the feed fluid at a pressure that is less than the liquid entry pressure of the hydrophobic material of the plurality of the hollow fibre membranes.

22. A method of fluid separation comprising:
providing the apparatus of claim 1;
feeding a feed fluid through the at least one second fluid passageway; and
extracting a permeate of the feed fluid from the plurality of third fluid passageways;
wherein the vapour pressure in the at least one second fluid passageway is greater than the vapour pressure in the plurality of third fluid passageways.

23. A method according to claim 22, comprising feeding the permeate of the feed fluid through the first fluid passageway to condense the permeate of the feed fluid.

24. A method according to claim 23, comprising increasing the temperature and pressure of the permeate of the feed fluid before feeding the permeate of the feed fluid through the first fluid passageway.

25. A method according to claim 22, wherein the plurality of third fluid passageways comprise air, a partial vacuum, a vacuum, a porous material or a liquid, or wherein extracting the permeate of the feed fluid from the plurality of third fluid passageways comprises feeding a sweep gas through the plurality of third fluid passageways.

26. (canceled)

27. A method according to claim 22, wherein feeding the feed fluid through the at least one second fluid passageway comprises feeding the feed fluid at a pressure that is less than the liquid entry pressure of the hydrophobic material of the plurality of the hollow fibre membranes.

28. A method for combining a gas with a liquid comprising:
providing the apparatus of claim 1;
feeding a feed liquid through one of the at least one second fluid passageway and the plurality of third fluid passageways; and
feeding a gas for combining with the feed liquid through the other of the at least one second fluid passageways and the plurality of third fluid passageways.

29. A method according to claim 28, comprising applying pressure to drive the gas through the plurality of the hollow fibre membranes.

30. A method according to claim 28, comprising regulating the temperature in the at least one second fluid passageway by feeding a regulating fluid through the first fluid passageway, optionally wherein the feed fluid is fed through the at least one second fluid passageway and the temperature of the regulating fluid is greater than the temperature of the feed fluid.

31. (canceled)
